(19) United States
(12) Patent Application Publication
(10) Pub. No.: US 2007/0182801 A1
(43) Pub. Date: Aug. 9, 2007

(54) Printing device, information providing system, printing method, and printed matter

(76) Inventors: Noriyoshi Shoji, Chiba-shi (JP); Kezuo Tani, Chiba-shi (JP); Akihiro Okabe, Chiba-shi (JP)

Correspondence Address: BRUCE L. ADAMS, ESQ., SUITE 1231, 17 BATTERY PLACE, NEW YORK, NY, 10004, US

(21) Appl. No.: 11/655,700

(22) Filed: Jan. 19, 2007

(30) Foreign Application Priority Data
Feb. 8, 2006 (JP) 2006-031203

(51) Int. Cl. B41J 2/01

(52) U.S. Cl. 347/104

(57) ABSTRACT

Provided are a printing device, an information providing system, and a printing method each capable of properly printing a dispersed image where information for specifying a plurality of websites is dispersed and human-readable information regarding each of the websites, and a printed matter obtained therethrough. A dispersed image generation unit (27) subjects ID pattern for designating a plurality of websites in a data storage unit (26) to inverse Fourier transform to disperse the ID pattern, and divides an image generated by the dispersion into the number equal to the plurality of websites, to thereby generate partial images. A printing unit (28) prints each partial image so as to be superposed on human-readable information such that multiple pieces of human-readable information in the data storage unit (26) can all be printed.

### BACKGROUND OF THE INVENTION

1. Field of the Invention

The present invention relates to a printing device, an information providing system, a printing method, and a printed matter, in particular, a printing device, an information providing system, and a printing method each for printing an image having an electronic watermark embedded therein, and a printed matter thus obtained.

2. Description of the Relater Art

The use of electronic information, e.g., a two-dimensional code such as a QR code, has become widespread in recent years. For example, the QR code is used as follows.

A user photographs a QR code generated based on a URL, which specifies a predetermined website, with a camera of a mobile telephone. Subsequently, the user has the QR decoded by the mobile telephone to obtain the URL, and connects to the website specified by the URL through a mobile telephone.

JP 2000-235669 A discloses a sales management terminal for printing a plurality of QR codes and a character for explaining information contained by each QR code on a receipt.

When human-readable information such as a character is superposed on a QR code, the QR code cannot be correctly decoded. Accordingly, when a plurality of QR codes and a character regarding each QR code are printed on a recording medium such as a receipt, a plurality of inorganic QR codes are printed.

FIG. 13 is an explanatory diagram showing a recording medium 103 such as a receipt on which a plurality of QR codes 101 and human-readable information 102 regarding each QR code are printed.

However, it is unfavorable to array many inorganic QR codes in terms of design. Besides, the printing of the plurality of inorganic QR codes and multiple pieces of human-readable information regarding the QR codes requires a larger space for printing.

### SUMMARY OF THE INVENTION

It is therefore an object of the present invention to provide a printing device, an information providing system, and a printing method each capable of properly printing a dispersed image where information for specifying a plurality of websites is dispersed, and a printed matter thus obtained.

In order to attain the above-mentioned object, a printing device according to the present invention includes:

a reception unit for receiving specific information for designating a plurality of websites;

an input unit for receiving human-readable information regarding each of the plurality of websites;

a dispersed image generation unit for generating a dispersed image including a plurality of partial images in which the specific information is dispersed; and

a printing section for printing the dispersed image and the human-readable information in a superposed manner.

Also, a printing method according to the present invention is implemented by a printing device, and includes:

a reception step of receiving specific information for designating a plurality of websites;

an input step of receiving human-readable information regarding each of the plurality of websites;

a dispersed image generation step of generating a dispersed image including a plurality of partial images in which the specific information is dispersed; and

a printing step of printing the dispersed image and the human-readable information in a superposed manner.

According to the invention, the dispersed image having specific information for specifying the plurality of websites dispersed therein is constituted of the plurality of partial images, and the human-readable information is shown on the dispersed image.

Accordingly, an outline of the plurality of websites contained in the dispersed image can be represented by the human-readable information. For example, the number of websites contained in the dispersed image can be represented by the number of partial images.

Thus, even when image information obtained by imaging the information for specifying the plurality of websites and the multiple pieces of human-readable information are printed together, it is possible to prevent arraying of multiple pieces of inorganic image information, and to efficiently print the image information and the multiple pieces of human-readable information on a limited printing space.

The printing device according to the present invention includes:

a reception unit for receiving multiple pieces of specific information to specify predetermined websites;

an input unit for receiving human-readable information regarding the specific information received by the reception unit;

a dispersed image generation unit for generating a dispersed image including a plurality of partial images in which the multiple pieces of specific information are dispersed; and

a printing unit for printing the dispersed image and the human-readable information regarding the specific information in a superposed manner.

Also, the printing method according to the present invention, which is implemented by a printing device, includes:

a reception step of receiving multiple pieces of specific information for specifying predetermined websites;

an input step of receiving human-readable information regarding the specific information;

a dispersed image generation step of generating a dispersed image including a plurality of partial images in which the multiple pieces of specific information are dispersed; and

a printing step of printing the dispersed image and the human-readable information regarding the specific information in a superposed manner.

According to the invention, the dispersed image having multiple pieces of specific information each specifying a predetermined website dispersed therein is constituted of the plurality of partial images, and the human-readable information is shown on the dispersed image.

Accordingly, an outline of the plurality of websites contained in the dispersed image can be represented by the human-readable information. For example, the number of websites contained in the dispersed image can be represented by the number of partial images.

Thus, even when image information obtained by imaging the information for specifying the plurality of websites and the multiple pieces of human-readable information are printed together, it is possible to prevent arraying of multiple pieces of inorganic image information, and to efficiently print the image information and the multiple pieces of human-readable information on a limited printing space.

Also, an information providing system according to the present invention includes:

a printing device; and

a printing control device for communicating with the printing device, in which:

the printing control device includes:
a storage unit for storing specific information for designating a plurality of websites and human-readable information regarding each of the plurality of websites;
a dispersed image generation unit for generating a dispersed image including a plurality of partial images in which the specific information stored in the storage unit is dispersed;
a printing image generation unit for generating a printing image in which the dispersed image generated by the dispersed image generation unit and the human-readable information stored in the storage unit are superposed on each other; and
a transmission unit for transmitting the printing image generated by the printing image generation unit to the printing device, and

the printing device includes:
a reception unit for receiving the printing image; and
a printing unit for printing an image according to the printing image received by the reception unit.

Also, the information providing system according to the present invention includes:

a printing device; and

a printing control device for communicating with the printing device, in which:

the printing control device includes:
a storage unit for storing multiple pieces of specific information for designating predetermined websites and human-readable information regarding the specific information;
a dispersed image generation unit for generating a dispersed image including a plurality of partial images in which the multiple pieces of specific information stored in the storage unit are dispersed;
a printing image generation unit for generating a printing image in which the dispersed image and the human-readable information regarding the specific information are superposed on each other; and
a transmission unit for transmitting the printing image generated by the printing image generation unit to the printing device, and

the printing device includes:
a reception unit for receiving the printing image; and
a printing unit for printing an image according to the printing image received by the reception unit.

Also, a printing method according to the present invention, which is implemented by an information providing system including a printing device, and a printing control device which communicates with the printing device, includes:

a dispersed image generation step of generating, by the printing control device, a dispersed image including a plurality of partial images in which the specific information is dispersed;

a printing image generation step of generating, by the printing control device, a printing image in which the dispersed image and the human-readable information are superposed on each other;

a transmission step of transmitting, by the printing control device, the printing image to the printing device;

a reception step of receiving, by the printing device, the printing image; and

a printing step of printing, by the printing device, an image according to the printing image.

Also, a printing method according to the present invention, which is implemented by an information providing system including a printing device, and a printing control device which communicates with the printing device and stores multiple pieces of specific information to designate predetermined websites and multiple pieces of human-readable information regarding the multiple pieces of specific information, includes:

a dispersed image generation step of generating, by the printing control device, a dispersed image including a plurality of partial images in which the multiple pieces of specific information are dispersed;

a printing image generation step of generating, by the printing control device, a printing image in which the dispersed image and the human-readable information regarding the specific information are superposed on each other;

a transmission step of transmitting, by the printing control device, the printing image to the printing device;

a reception step of receiving, by the printing device, the printing image; and

a printing step of printing, by the printing device, an image according to the printing image.

According to the invention, as the printing control device generates the dispersed image, a processing load of the printing device can be reduced as compared with a case where the printing device generates a dispersed image.

Each of the multiple pieces of human-readable information may correspond to each of the multiple pieces of specific information, the dispersed image generation unit may generate the multiple pieces of partial images by dispersing each of the multiple pieces of specific information, and the partial images and the pieces of human-readable information corresponding to the partial images may be printed in a superposed manner.

According to the invention, when the partial image is decoded, only a part of the specific information corresponding to the partial image is obtained. The specific information contained in the partial image can be indicated by the human-readable information printed on the partial image in a superposed manner. Thus, only necessary piece can be obtained among the multiple pieces of specific information can be obtained. Hence, it is possible to prevent acquisition of unnecessary specific information.

Also, it is preferable that the dispersed image generation unit decides on sizes of the partial images according to size designation information for designating the sizes of the plurality of partial images.

According to the invention, it is possible to adjust the sizes of the partial images.

Also, the present invention provides a printed matter in which a dispersed image having specific information for designating a plurality of websites dispersed therein and including partial images equal in number to the plurality of websites, and pieces of human-readable information equal in number to the plurality of websites are superposed on each other.

Also, the present invention provides a printed matter in which a dispersed image having multiple pieces of specific information for specifying a predetermined website dispersed therein and including partial images equal in number to the multiple pieces of specific information, and pieces of human-readable information equal in number to the multiple pieces of specific information are superposed on each other.

According to the invention, as the information to specify the plurality of websites is dispersed, the specific information is less likely to interfere with user's viewing of the human-readable information.

According to the present invention, the dispersed image having the information for specifying the plurality of websites dispersed therein is constituted of a plurality of partial images, and superposed on the human-readable information to be displayed. Thus, it is possible to represent an outline of the plurality of websites by the human-readable information.

Thus, even when the image information for specifying the plurality of websites and the multiple pieces of human-readable information are printed together, it is possible to prevent arraying of multiple pieces of inorganic image information, and to efficiently print the information for specifying the plurality of websites and the multiple pieces of human-readable information on a limited printing space.

### BRIEF DESCRIPTION OF THE DRAWINGS

In the accompanying drawings:

FIG. 1 is a diagram for explaining an outline of an embodiment of the present invention;

FIG. 2 is block diagram showing a configuration of an information providing system 1 according to this embodiment shown in FIG. 1;

FIG. 3 is a block diagram showing an example of a logical configuration of an ID database disposed in a URL server 2 of FIG. 2;

FIGS. 4A and 4B are explanatory diagrams showing examples of receipts having ID background images printed thereon;

FIG. 5 is a block diagram showing a configuration of a printer 3;

FIG. 6 is a block diagram showing a gradation representation method;

FIG. 7 is a block diagram showing a configuration of the printer 3;

FIG. 8 is a flowchart showing an operation of the printer 3;

FIG. 9 is a flowchart showing another operation of the printer 3;

FIGS. 10A and 10B are explanatory diagrams showing examples of screens displayed on mobile telephones regarding photographing of a receipt;

FIG. 11 is a flowchart showing a procedure of connecting a mobile telephone 5 to a service server 6;

FIG. 12 is a diagram for explaining a modified example of a method of printing an ID background image; and

FIG. 13 is an explanatory diagram showing a conventional example of printing.

### DESCRIPTION OF THE PREFERRED EMBODIMENTS

### (1) Outline of Embodiment

In a printing device of an embodiment according to the present invention, specific information is defined in a frequency domain, and the information is subjected to the inverse Fourier transform (the information is dispersed). For example, the specific information indicates an ID pattern associated with uniform resource locators (URL) of a predetermine website. In the predetermined website, for example, URL of a plurality of websites may be displayed, or URL of one website may be displayed. Hereinafter, the ID pattern is used as specific information.

The printing device executes the inverse Fourier transform as described above to thereby generate a pattern having ID patterns dispersed in an entire screen (dispersed image: hereinafter referred to as ID background image).

More specifically, the printing device generates an ID background image which has dispersed ID patterns and is constituted of partial images equal in number to that of URLs of a plurality of websites displayed in a website associated with the ID patterns (hereinafter referred to as “number of URLs”).

The printing device may subject one ID pattern to inverse Fourier transform, and divide an image generated by the inverse Fourier transform into the number of URLs to thereby generate a plurality of partial images, or disperse each of a plurality of ID patterns to thereby generate a plurality of partial images.

The printing device prints the ID background image and human-readable information constituted of a character or an image (design) in a superposed manner.

When the printing device generates a plurality of partial images by dividing an image generated by the inverse Fourier transform into the number of URLs, the number of pieces of human-readable information is equal to that of URLs. When the printing device generates a plurality of partial images by dispersing each of a plurality of ID patterns, the number of pieces of human-readable information is equal to that of ID patterns.

The printing device prints each partial image so as to be superposed on a piece of human-readable information so that all the multiple pieces of human-readable information can be superposed on the ID background image to be printed.

The ID background image is lost in a portion where the human-readable information is printed. However, the ID patterns can be restored by subjecting a pattern of a remaining portion of the ID background image to the Fourier transform.

By experiments, it has been confirmed that the original ID patterns can be restored even if about 50% of the ID background image is lost.

According to this embodiment, a printed medium (e.g., receipt) on which the ID background image and the human-readable information are printed in a superposed manner is photographed with a camera of a mobile telephone, and data of the photographed image is transmitted from the mobile telephone to a URL server.

The URL server receives the data of the photographed image from the mobile telephone, and subjects this data to the Fourier transform, to thereby extract an ID pattern.

The URL server stores the ID pattern and a URL associated with the ID pattern in a corresponding manner, retrieves the URL corresponding to the extracted ID pattern, and transmits the URL to the mobile telephone.

The mobile telephone connects with a website designated by the URL sent from the URL server and use services provided by the website.

As described above, according to this embodiment, the URL is associated with the printed medium through the ID background image.

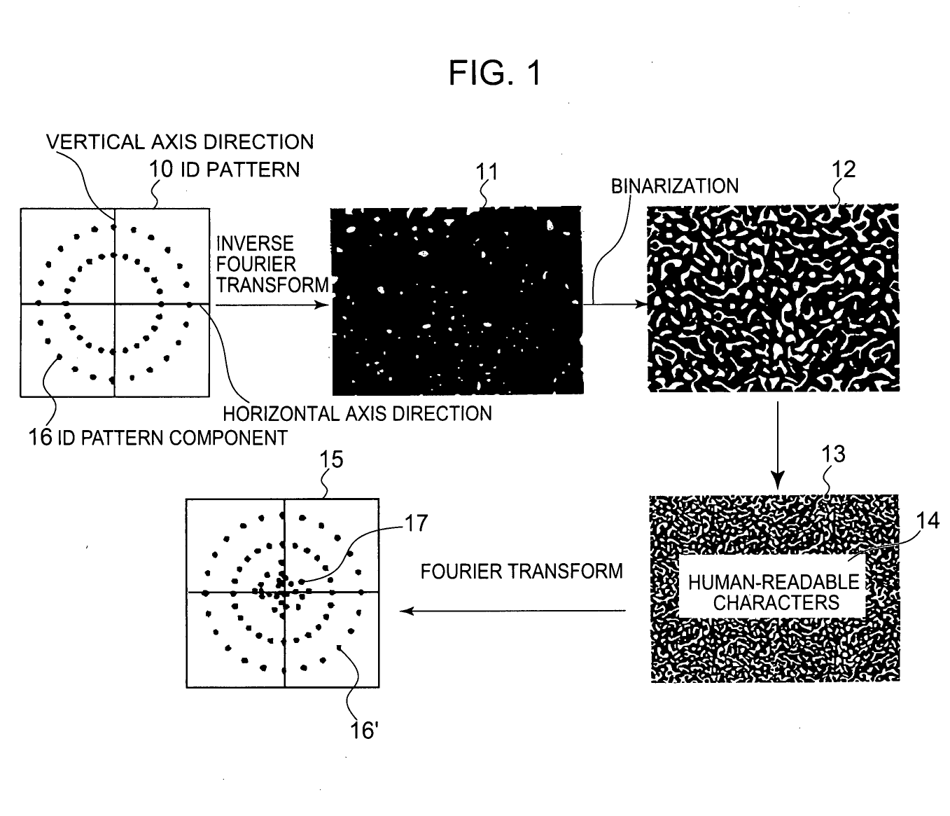

FIG. 1 is a diagram for explaining an outline of the embodiment.

To begin with, dispersion (inverse Fourier transform) of ID patterns and decoding (Fourier transform) of the dispersed ID patterns will be described.

First, an ID pattern 10 is defined in a frequency domain.

The ID pattern 10 is constituted of ID pattern components 16 which are points dispersed on circumferences of inner and outer peripheral circles.

An original point of vertical and horizontal axes is on a low-frequency side, and points farther from the original point are on higher frequency sides.

When the ID pattern 10 is subjected to the inverse Fourier transform, an ID background image 11 in a real space is obtained. In the ID background image 11, patterns are diffused (dispersed) in the entire image.

In defining the ID pattern 10, it is preferable to select a pattern in which the ID background image 11 after the inverse Fourier transform is dispersed in the entire image as described above.

The ID background image 11 can be obtained by subjecting the ID pattern 10 to the inverse Fourier transform. Conversely, the ID pattern 10 can be obtained by subjecting the ID background image 11 to the Fourier transform.

Thus, when a proper ID pattern is selected and subjected to the inverse Fourier transform, information for restoring the ID pattern is diffused in the entire ID background image 11, to thereby generate resistance to processing such as compression or cutting-out.

In other words, even when an image is expanded/reduced or partially cut out, the ID pattern can be restored from information left in the image because information for defining the ID pattern is diffused in the entire image.

According to this embodiment, the ID background image 11 is binarized so as to be printed with a small printing device such as a receipt printing mechanism of a cash register, and a binarized ID background image 12 is generated.

Then, shading of the ID background image 12 is adjusted so that human-readable information can be viewed, and the ID background image 12 and the human-readable information 14 after the shading adjustment are printed in a superposed manner, to thereby generate a printed matter 13.

Digital image data obtained by photographing the printed matter 13 with the camera is subjected to the Fourier transform, to thereby obtain an ID pattern 15.

In the ID pattern 15, an ID pattern component 16′ is restored, and a frequency component 17 is formed based on the human-readable information 14. As the frequency component 17 based on the human-readable information 14 tends to be unevenly distributed to a low frequency side, the frequency component 17 and the ID pattern component 16′ can be distinguished from each other, and therefore the ID pattern component 16′ can be extracted.

By extracting the ID pattern component 16′ restored from the ID pattern 15 as described above to check coincidence with the ID pattern component 16 of the ID pattern 10, it is possible to specify the ID pattern included in the printed matter 13.

According to this embodiment, the printing device divides the image subjected to the inverse Fourier transform into the number of URLs to generate a plurality of partial images, or disperses each of the plurality of ID patterns to generate a plurality of partial images.

Furthermore, each partial image is printed on a piece of human-readable information in a superposed manner so that all the multiple pieces of human-readable information can be printed on the ID background image 11 in a superposed manner.

### (2) Details of Embodiment

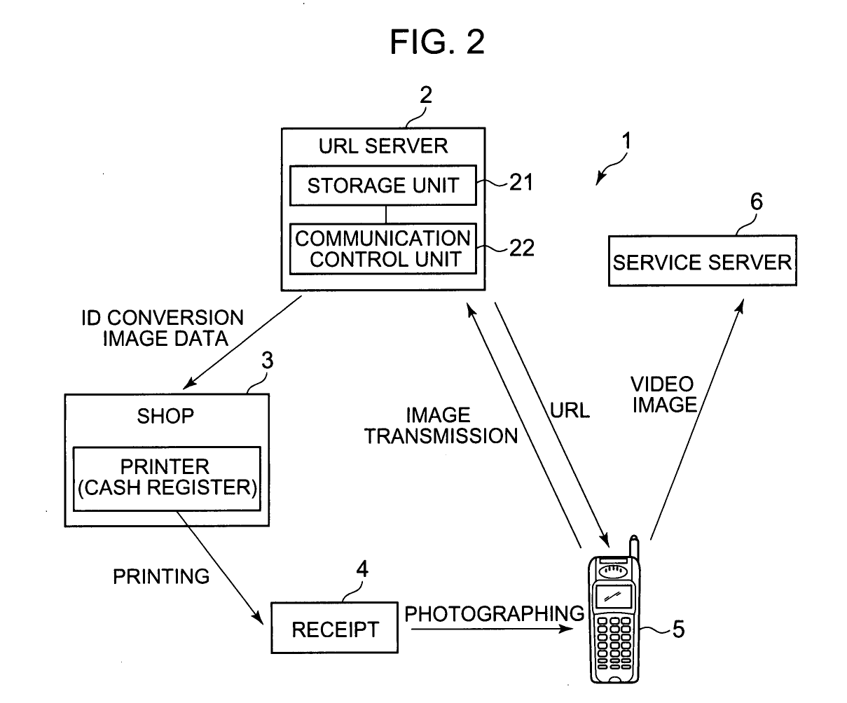

FIG. 2 is a block diagram showing a configuration of an information providing system 1 according to this embodiment.

The information providing system 1 includes a URL server 2, a printer (printing device) 3, a receipt 4, a mobile telephone 5, and a service server 6.

In FIG. 2, the printer 3 and the mobile telephone 5 are shown each by one. However, there are provided more than one of each of the printer 3 and the mobile telephone 5.

The URL server 2 is an example of a printing control device, and includes a storage unit 21 and a communication control unit 22.

The storage unit 21 stores an ID database including the ID pattern 10 (see FIG. 1), the URL, and a plurality of human-readable characters (human-readable information), and a plurality of display area sizes which are correlated with one another. The communication control unit 22 provides the ID pattern 10, the plurality of human-readable characters, and the plurality of display area sizes to the printer 3 or the URL to the mobile telephone 5, by using this ID database.

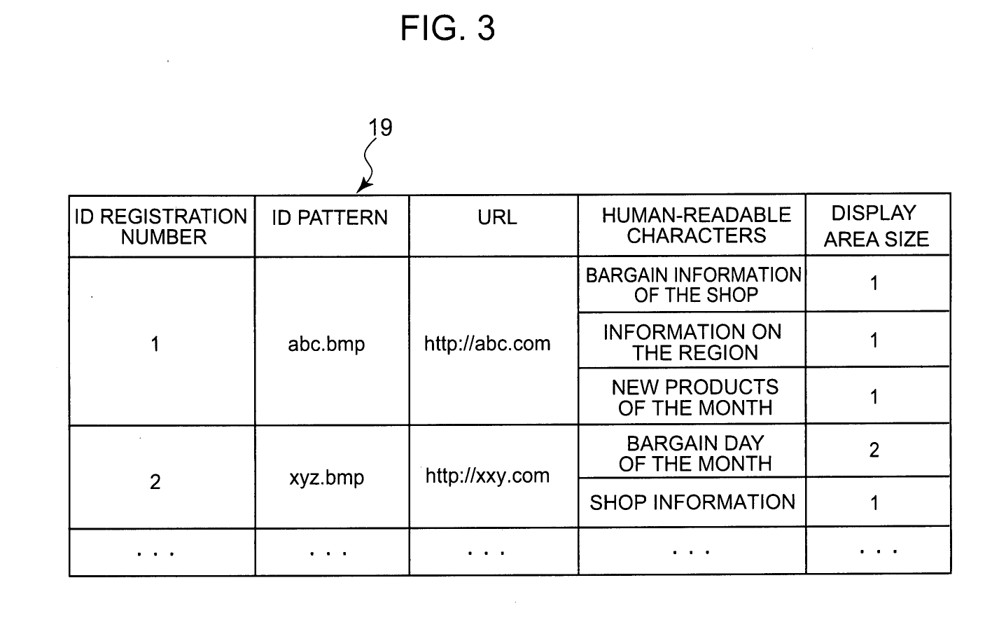

FIG. 3 is a diagram showing an example of a logical configuration of the ID database.

The ID database 19 includes items such as “ID registration number”, “ID pattern”, “URL”, “human-readable character”, and “display area size”. “ID pattern”, “URL”, a plurality of “human-readable characters”, and a plurality of “display area sizes” having the same “ID registration number” are correlated with one another.

The “ID registration number” is a management number for managing an ID pattern or a URL, and uniquely assigned to each set of “ID pattern”, “URL”, a plurality of “human-readable characters”, and a plurality of “display area sizes”.

An image (corresponding to the ID pattern 10 of FIG. 1) defining an ID pattern is stored in the “ID pattern”.

A URL that is connection information for connection to a predetermined website is stored in the “URL”. For example, in this predetermined website, URLs of a plurality of websites are displayed.

In the plurality of “human-readable characters”, for example, characters (human-readable information: e.g., “bargain information of the shop”, “information on the region”, and “new products of the month”) associated with the plurality of websites displayed in the predetermined website specified by the “URL” are stored. Accordingly, the number of “human-readable characters” and the number of multiple websites displayed in the predetermined website specified by the “URL” are equal to each other.

A size of a background area (partial image) for “human-readable character” is stored in the “display area size”. For example, the “display area size” may be varied depending on a company (e.g., advertiser) having a URL corresponding to “human-readable character” correlated with “size of display”.

The ID database 19 stores the “ID pattern”, the “URL”, the plurality of “human-readable characters”, and the plurality of “display area sizes”, and when an ID pattern is specified, a URL corresponding to this ID pattern is obtained.

Next, a function owned by the URL server 2 of providing information to the printer 3 will be described.

For example, the URL server 2 and the printer 3 can be interconnected via a network such as the Internet.

According to this embodiment, the URL server 2 provides an ID pattern, and a plurality of human-readable characters and a plurality of display area sizes corresponding to the ID pattern, to the printer 3 via the network.

Next, a function owned by the URL server 2 of providing a URL to the mobile telephone 5 will be described.

The URL sever 2 (FIG. 2) receives data of an image obtained by photographing the receipt 4, from the mobile telephone 5.

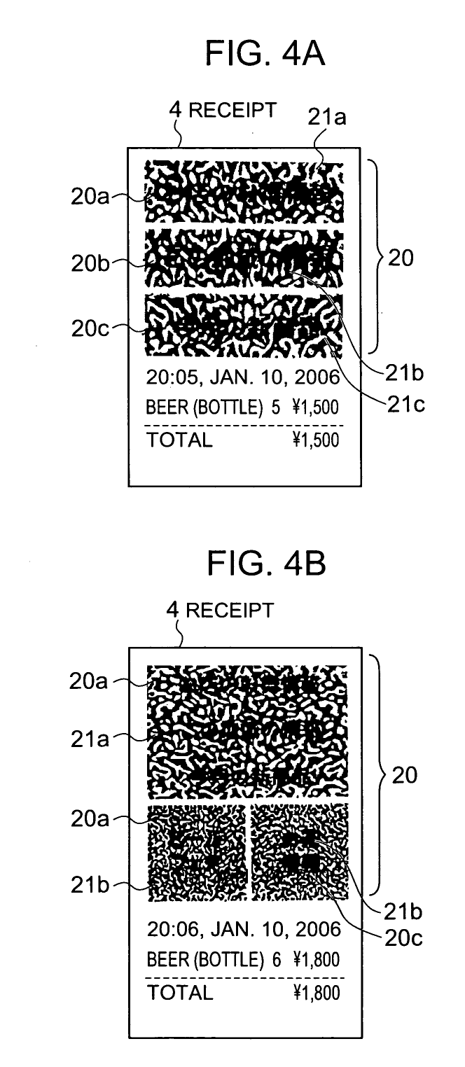

The receipt 4 is a printed medium produced by the printer 3. In its appearance, as shown in FIGS. 4A and 4B, multiple pieces of human-readable information 21a to 21c are printed against a background of an ID background image 20 constituted of a plurality of partial images 20a to 20c.

When a plurality of partial images 20a to 20c are generated by dispersing one ID pattern and dividing an image generated by the dispersion into the number equal to the number of human-readable characters corresponding to the ID pattern (specifically, the number of websites displayed in a predetermined website specified by a URL corresponding to the ID pattern), a user photographs an entire ID background image 20 constituted of the plurality of partial images 20a to 20c with the mobile telephone 5.

When the plurality of partial images 20a to 20c are generated by dispersing each of the plurality of ID patterns, the user photographs one of the partial images 20a to 20c with the mobile telephone 5.

Upon reception of the photographed image data from the mobile telephone 5, the URL server 2 subjects this data to the Fourier transform to restore the ID pattern.

The URL server 2 extracts the restored ID pattern to compare the ID pattern with the ID patterns registered in the ID database 19.

Then, the URL server 2 transmits a URL correlated with the ID pattern specified by the comparison to the mobile telephone 5.

According to this embodiment, the Fourier transform of the photographed image and the extraction of the ID pattern are carried out by the URL server 2. However, the mobile telephone 5 may execute the process up to the extraction of the ID pattern and then transmit it to the URL server 2.

In the case where the URL server 2 carries out the extraction of the ID pattern, it is not necessary to provide the mobile telephone 5 with an image processing function of extracting the ID pattern. Thus, a load on the mobile telephone 5 can be reduced.

On the other hand, in the case where the mobile telephone 5 carries out the extraction of the ID pattern, image data obtained by mistake in the mobile telephone 5 is not transmitted to the URL server 2, and it is not necessary to execute image processing at the URL server 2. Thus, a load on the URL server 2 can be reduced.

Next, the printer 3 will be described. For example, the printer 3 is a cash register installed at a checkout counter of a shop, and equipped with checkout and receipt printing functions.

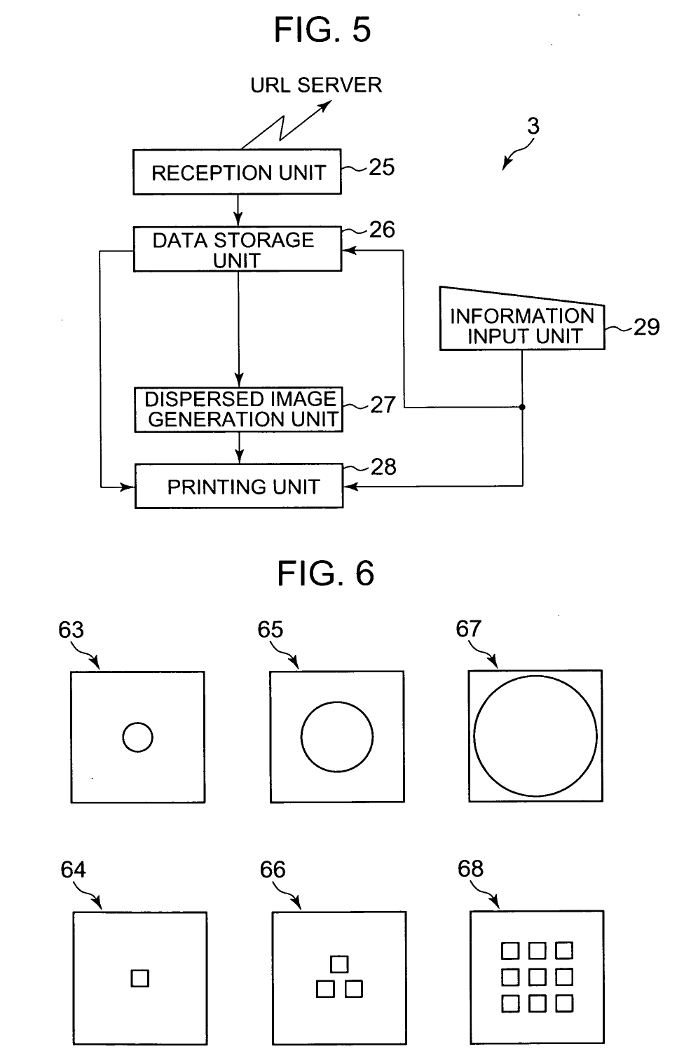

FIG. 5 is a block diagram showing an example of a functional configuration of the printer 3.

The printer 3 includes a reception unit 25, a data storage unit 26, a dispersed image generation unit 27, a printing unit 28, and an information input unit 29.

The reception unit 25 is an example of one of a reception unit, an input unit, a designated information reception unit, and a communication unit. The reception unit 25 can communicate with the URL server 2, and receives “ID pattern”, and a plurality of “human-readable characters” (human-readable information) and a plurality of “display area sizes” corresponding to the “ID pattern”, from the URL server 2.

For information transmitted from the URL server 2 to the reception unit 25, the printer 3 may request the URL server 2 for information corresponding to an ID registration number, or the URL server 2 may decide on information to be transmitted.

The data storage unit 26 is configured by using a recording medium such as a hard disk or a semiconductor memory, and stores the information which the reception unit 25 has received from the URL server 2.

The dispersed image generation unit 25 generates a dispersed image constituted of “ID pattern” stored in the data storage unit 26 which has been dispersed and partial images equal in number to “human-readable characters” stored in the data storage unit 26.

For example, the dispersed image generation unit 27 subjects the ID pattern stored in the data storage unit 26 to the Fourier transform and disperses the ID pattern, and divides the image generated by the dispersion into the number equal to the number of human-readable characters stored in the data storage unit 26, to thereby generate a plurality of partial images (FIGS. 4A and 4B).

In this case, the dispersed image generation unit 27 decides sizes of the partial images according to the plurality of “display area sizes” (size designation information) stored in the data storage unit 26. For example, the dispersed image generation unit 27 divides the image generated by the dispersion by rates of numerical values indicated by the plurality of “display area sizes”, to there by decide sizes of the partial images.

Additionally, for example, the dispersed image generation unit 27 generates a plurality of partial images by dispersing each of the plurality of ID patterns stored in the data storage unit 26. The plurality of partial images are closely arranged but not to overlap one another.

In this case, for each ID pattern, the URL server 2 stores “partial image size designation information” for designating a size of a partial image corresponding to the ID pattern, and transmits the partial image size designation information corresponding to the ID pattern to the printer 3 together with the ID pattern. The printer 3 stores the partial image size designation information in the data storage unit 26 by associating the partial image size designation information with the corresponding ID pattern.

The dispersed image generation unit 27 decides on sizes of partial images generated from ID patterns corresponding to partial image size designation information and their positions in the dispersed image according to multiple pieces of partial image size designation information stored in the data storage unit 26. For example, the dispersed image generation unit 27 enlarges a partial image corresponding to partial image size designation information, and arranges the partial image in a position near a center of the dispersed image as a numerical value indicated by the partial image size designation information increases.

The information input unit 29 is an example of one of a reception unit, an input unit, and a designation information reception unit, and includes a numeric keypad, function keys, a barcode reader, I/O devices of various storage media, and the like.

The information input unit 29 receives entries of product specification information for specifying products and the quantity thereof. Product codes are assigned to products sold at a shop by, e.g., barcodes. The printer 3 stores accessory information regarding the relevant products such as prices of the products and product names in association with the product codes.

Accordingly, a cashier enters product codes and the quantity thereof from the information input unit 29, whereby the printer 3 can carry out checkout calculation.

The printing unit 28 generates items (printing contents) to be printed on a receipt based on the product codes and the quantity entered from the information input unit 29 or on the prices stored corresponding to the product codes.

For example, the printing contents include names of products, a quantity, unit prices of the products, a total amount of products for checkout, checkout date and time, and a name and a logo mark of a shop.

The printing unit 28 prints each partial image generated by the dispersed image generation unit 27 by superposing it on the human-readable information so that all the multiple pieces of human-readable information stored in the data storage unit 26 can be printed (FIG. 4).

When the dispersed image generation unit 27 generates a plurality of partial images by dispersing one ID pattern and dividing the dispersed image, the printing unit 28 selects “human-readable information” in the decreasing order of “display area sizes” which are related to the “human-readable information”, and prints the selected “human-readable information” by superposing it on a largest partial image having no “human-readable information” superposed yet, each time “human-readable information” is selected.

When the dispersed image generation unit 27 generates a plurality of partial images by dispersing each of the plurality of ID patterns, the printing unit 28 prints “human-readable information” by superposing it on a partial image having an ID pattern corresponding to the “human-readable information” dispersed.

The human-readable information is written over a partial image. In other words, information of a part of partial images where human-readable information is printed is replaced with the human-readable information.

Accordingly, while information of an ID background image is lost in an area where the human-readable information is printed, the ID pattern can be restored from a part remaining as a background up to the extent that the restored ID pattern can be compared with its original image.

By experiments, it has been confirmed that the ID pattern can be restored even if about 50% of the ID background image is lost on an area basis.

Thus, the printing unit 28 sets an area of a part where the ID background image and the human-readable information are printed in a superposed manner to be equal to or less than 50% of the area of the ID background image.

The printing unit 28 has a function of adjusting shading of each of the ID background image and the human-readable information independently.

The reason for this is that, as the human-readable information becomes difficult to recognize through visual inspection when printing of the ID background image is too dark, it is necessary to print the ID background image as light as possible within a range that the ID pattern can still be reproduced.

The printing unit 28 can adjust shading of the human-readable information and other printed contents to be suited for viewing.

The user (cashier) of the printer 3 operates the printer 3 by using a shading adjustment screen or the like displayed in the display device of the printer 3 to fine-adjust shading of the ID background image and the printed contents.

The printing unit 28 prints a receipt based on the shading set by the user.

A printed medium is, for example, a roll of paper wound in a roll shape and housed. The printing unit 28 executes printing by coloring a single-color dot on the printed medium. The printing unit 28 includes a cutter, and cuts the printed medium at a proper place when the printing is finished.

For a printing method, various methods such as an impact method and a nonimpact method can be used.

As the impact method, for example, there is a method of transferring ink of an ink ribbon by striking a pin of a printing head on the printed medium. According to this method, a background screen and printed contents are printed by distributing the ink on the printed medium according to contents to be printed.

As the nonimpact method, for example, there is a thermal-transfer method. According to this method, heat-sensitive paper ink included in the printed medium is colored by Joule heat generated as a result of energizing a thermal head. A printing device adopting this method can be made compact, light in weight, and maintenance-free, and therefore the thermal-transfer method is popularly used in a device having simple printing functions such as a cash register.

Other nonimpact methods are those using an ink jet and a laser.

The method of adjusting image shading includes a density gradation method for changing a density of a pixel (cell) which is a printing unit, and an area gradation method for changing a dot area ratio in a pixel. Any one of these methods can be used, but the printing unit 28 employs the area gradation method.

The ID background image includes digital data. In the case of executing area gradation by a digital method, a pixel is generally constituted of a binary dot.

Thus, as schematically shown in FIG. 6, the printing unit 28 has a function of correlating area gradation with a single binary dot having a rectangle shape (or other shapes) and executing area gradation based on an arrangement of this binary dot.

In the example of FIG. 6, a dot of a small area in a pixel 63 is correlated with one binary dot in a pixel 64, a dot of a medium area in a pixel 65 is correlated with three binary dots in a pixel 66, and a dot of a large area in a pixel 67 is correlated with nine binary dots in a pixel 68.

The printing unit 28 stores correspondence between the area gradation and the binary dot, and obtains an arrangement of binary dots according to shading set by the user.

FIG. 6 shows only one example of area gradation. Various correspondences of arrangements of binary dots to execute area gradation are conceivable.

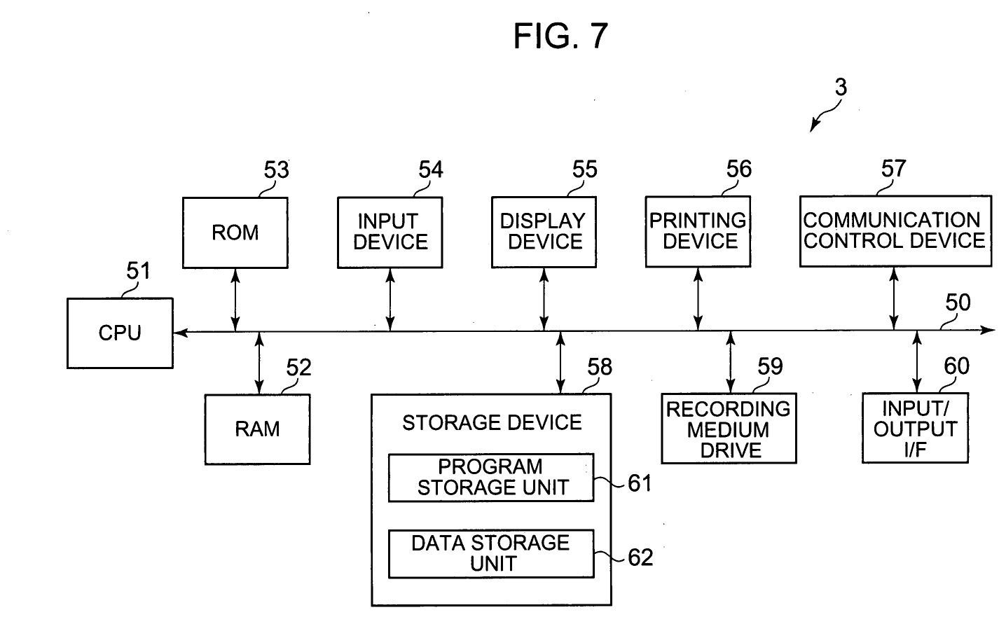

FIG. 7 is a block diagram showing a hardware configuration of the printer 3.

In the printer 3, hardware including a central processing unit (CPU) 51, a random access memory (RAM) 52, a read-only memory (ROM) 53, an input device 54, a display device 55, a printing device 56 (printing unit 28 of FIG. 5), a communication control device 57, a storage device 58, a recording medium drive 59, and an input/output I/F (interface) 69 are interconnected via a bus line 50.

The CPU 51 executes various arithmetic operations and information processing, and controls the components of the printer 3, according to predetermined programs stored in the ROM 53. The CPU 51 realizes the functions of the dispersed image generation unit 27 shown in FIG. 27 by executing the predetermined programs.

The ROM 53 is a memory for storing basic programs and data for operating the printer 3, and the RAM 52 is a readable/writable memory for providing a working area to operate the CPU 51.

The input device 54 is hardware constituting the information input unit 29 (FIG. 5), and includes numeric keypad, function keys, a barcode reader, and other input device.

The display device 55 displays character information or image information such as a total amount of purchase obtained as a result of checkout processing, for a customer. For example, the display device 5 includes a liquid crystal display, a plasma display, or a CRT.

The communication control device 57 is a function unit for connecting the printer 3 to the Internet. The printer 3 communicates with the URL server 2 and other server device via the communication control device 57.

When a sales management server of headquarters manages sales, the printer 3 connects with the sales management server via the communication control device 57 and transmits sales data such as earnings.

The printing device 56 is hardware constituting the printing unit 28 (FIG. 5).

The recording medium drive 59 is a function unit for driving a recording medium which is detachably loaded, and reading and writing data.

The recording medium is computer readable/writable, e.g., an optical disk such as a CD-ROM.

The printer 3 can install programs from the recording medium loaded on the recording medium drive 59 as well as read an ID background image stored in the recording medium to store the image in the data storage unit 26, or write stored checkout processing data in the recording medium.

For example, the storage device 58 is a large-capacity readable/writable storage device constituted of a hard disk or the like. In the storage device 58, a program storage unit 61 for storing programs, and a data storage unit 62 for storing data are formed.

The program storage unit 61 stores various programs executable by the CPU 51, such as OS (operating system), communication program, and checkout processing program.

The OS is a program for causing the CPU 51 to execute basic control for operating the printer 3 such as management of file input/output or control of various function units.

The communication program is a program for causing the CPU 51 to execute control for communication by the communication control device 57 via the Internet.

The checkout processing program is a program for causing the printer 3 to execute processing including receipt issuance, and causes the CPU 51 to execute various processings regarding the receipt issuance.

The data storage unit 62 stores information downloaded from the URL server 2, or the like.

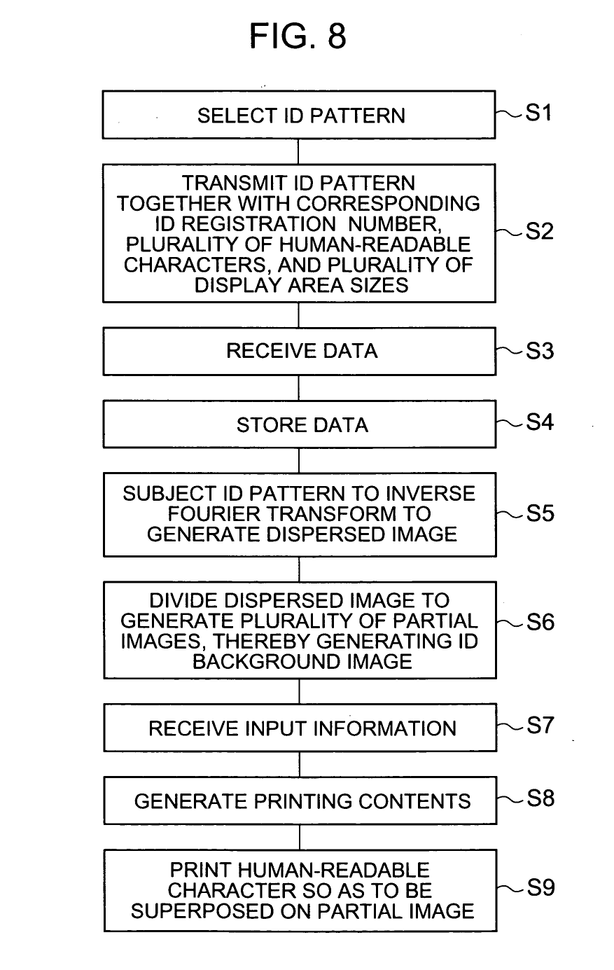

FIG. 8 is a flowchart showing a procedure performed by the printer 3 to print a receipt. Specifically, this flowchart shows a procedure of the printer 3 for generating an ID background image by dispersing an ID pattern and dividing an image obtained by the dispersion, to thereby print the receipt.

First, the communication control unit 22 of the URL server 2 selects an ID pattern to be transmitted to the printer 3 from the ID database (FIG. 3) of the storage unit 21 (Step 1).

Next, the communication control unit 22 associates the selected ID pattern with an ID registration number, a plurality of human-readable characters, and a plurality of sizes of displays corresponding to the ID pattern, and transmits it to the printer 3 (Step 2).

Then, the reception unit 25 of the printer 3 receives the ID pattern, the ID registration number, the plurality of human-readable characters, and the plurality of display area sizes, from the communication control unit 22 (Step 3).

The reception unit 25 associates the ID pattern with the corresponding ID registration number, the plurality of human-readable characters, and the plurality of display area sizes, and stores it in the data storage unit 26 (Step 4).

Then, the dispersed image generation unit 27 generates a dispersed image by subjecting the ID pattern stored in the data storage unit 26 to the inverse Fourier transform (Step 5).

The dispersed image generation unit 27 generates a plurality of partial images by dividing the dispersed image into the number equal to the number of human-readable characters at a rate of the plurality of display area sizes (Step 6). The dispersed image generation unit 27 stores an ID background image constituted of the plurality of partial images.

Subsequently, the information input unit 29 receives input information (Step 7). This input information contains product codes, the number of products, and the like.

Then, the printing unit 28 generates items (printing contents) to be printed on a receipt based on the input information received by the information input unit 29 (Step 8).

Next, the printing unit 28 selects human-readable characters in the decreasing order of the corresponding the display area sizes from the data storage unit 26, and prints a selected human-readable character by superposing it on a largest partial image having no human-readable character superposed yet, each time the human-readable character is selected. The printing unit 28 then prints the generated contents in the receipt (Step 9).

As a result, as shown in FIGS. 4A and 4B, a receipt 4 having the ID pattern embedded therein is generated.

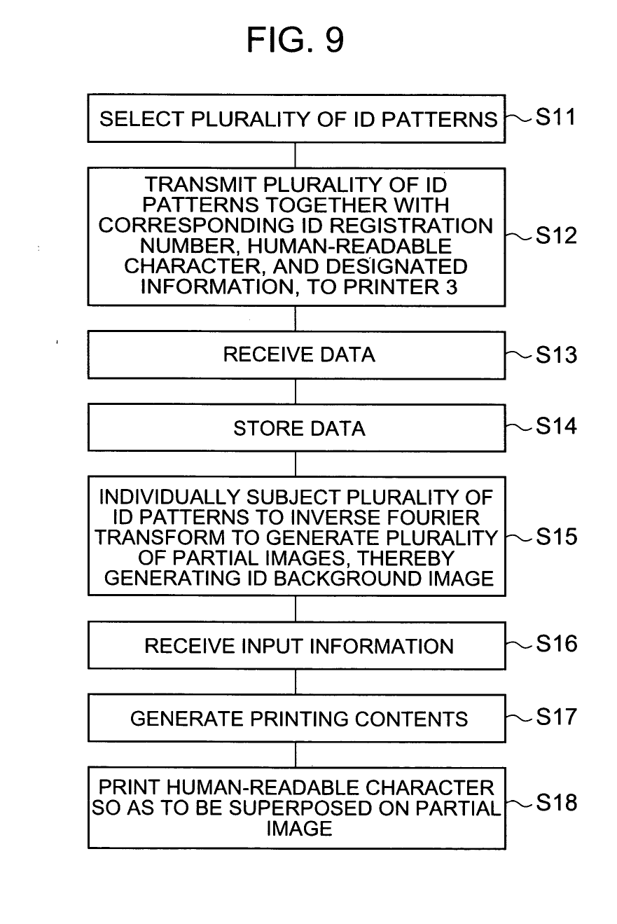

FIG. 9 is a flowchart showing another procedure performed by the printer 3 to print a receipt. Specifically, this flowchart shows a procedure of the printer 3 for printing the receipt by dispersing each of a plurality of ID patterns and generating a plurality of partial images.

In this case, it is assumed that partial image size designation information (hereinafter referred to as “designation information”) designating a size of a partial image corresponding to an ID pattern is stored in the storage unit 21 of the URL server 2 for each ID pattern.

First, the communication control unit 22 of the URL server 2 selects a plurality of ID patterns to be transmitted to the printer 3 from the ID database of the storage unit 21 (Step 11).

Next, the communication control unit 22 associates the selected plurality of ID patterns with an ID registration number, a plurality of human-readable characters, and multiple pieces of designation information corresponding thereto and transmits them to the printer 3 (Step 12).

Then, the reception unit 25 of the printer 3 receives the plurality of ID patterns, the plurality of ID registration numbers, the plurality of human-readable characters, and the plurality of pieces of designation information from the communication control unit 22 (Step 13).

The reception unit 25 associates each of the ID patterns with the corresponding ID registration number, the human-readable character, and the designation information, and stores it in the data storage unit 26 (Step 14).

Upon completion of Step 14, the dispersed image generation unit 27 individually divides the plurality of ID patterns stored in the data storage unit 26 to generate a plurality of partial images. At this time, the dispersed image generation unit 27 decides on the sizes of partial images generated from ID patterns corresponding to designation information and their positions in the dispersed image according to multiple pieces of designation information stored in the data storage unit 26 (Step 15).

For example, the dispersed image generation unit 26 enlarges partial images corresponding to designation information, and arranges them in positions nearer the center of the dispersed image as a value of the designation information is larger. The dispersed image generation unit 27 stores an ID background image constituted of the plurality of partial images.

Then, the information input unit 29 receives input information (Step 16). This input information contains product codes, the number of products, and the like.

The printing unit 28 generates items (printing contents) to be printed in a receipt based on the input information received by the information input unit 29 (Step 17).

Upon completion of Step 17, the printing unit 28 prints, in a superimposed manner, a human-readable character stored in the data storage unit 26 on the partial image where an ID pattern corresponding to the human-readable character is dispersed, and then prints the generated printing contents in the receipt (Step 18).

In this case, a receipt 4 similar to that having an ID pattern embedded therein shown in FIGS. 4A and 4B is generated.

For example, when “ID registration number” of the ID database of the URL server 2 corresponds to a classification of a product, and the URL server 2 has a product database associating product codes with classified products (e.g., database having association information such as chocolate (product code) associated with sweets (classified products), wine (product code) associated with liquor (classified products), and cabbage (product code) associated with vegetable (classified products)), the printer 3 may transmit a product code received by the information input unit 29 as information to designate the ID registration number to the URL server 2.

In this case, the communication control unit 22 of the URL server 2 refers to the product database to specify classified products corresponding to the product code, and selects “ID registration number” corresponding to the specified classified products. Subsequently, the communication control unit 22 of the URL server 2 transmits “ID pattern” corresponding to the selected “ID registration number”, and a plurality of “human-readable characters” and a plurality of “display area sizes” corresponding to the “ID pattern” to the printer 3.

Then, the printer 3 generates an ID background image as described above, and prints human-readable information so as to be superposed on the partial image.

In this case, a site considered to be most attractive to a customer can be provided to the customer.

For example, when the human-readable information in the ID database of the URL server 2 corresponds to a classification of a product, the URL server 2 has a product database associating product codes with classified products, and the printer 3 disperses one ID pattern and divides the dispersed image to generate a plurality of partial images, the size of a partial image on which the human-readable information is superposed may be changed as follows.

First, the printer 3 transmits the product code received by the information input unit 29 to the URL server 2, and the communication control unit 22 of the URL server 2 refers to the product database to specify classified products corresponding to the product codes.

Subsequently, when there is “human-readable information” corresponding to the specified classified products in the “human-readable information” scheduled to be transmitted to the printer 3, the communication control unit 22 changes a value of “display area size” corresponding to the “human-readable information” to the largest value of “display area sizes” scheduled to be transmitted to the printer 3, and then transmits “ID pattern” scheduled to be transmitted, and a plurality of “human-readable characters” and a plurality of “display area sizes” corresponding to the “ID pattern” to the printer 3.

Then, the printer 3 generates an ID background image as described above, and prints human-readable information so as to be superposed on the partial image.

When “ID registration number” in the ID database of the URL server 2 corresponds to a classification of a product, the URL server 2 has a product database associating product codes with classified products, and the printer 3 separately disperses a plurality (three in the example) of ID patterns to generate a plurality of partial images, the size of a partial image on which human-readable information is superposed may be changed as follows.

For example, it is presumed that URLs of six types of sites regarding sweets, liquor, vegetables, fruits, fish, and meats are prepared in the ID database 19 of the URL server 2.

First, the printer 3 transmits all product codes received by the information input unit 29 to the URL server 2, and the communication control unit 22 of the URL server 2 refers to the product database to specify product codes corresponding to the six types of classifications.

Then, the communication unit 22 classifies the specified product codes according to the six types, and investigates the first to third types in order of the greater number of classified product codes.

The communication control unit 22 changes “display area sizes” in the ID database 19 so that “display area size” correlated with the first type and corresponding to “ID registration number” can be larger than “display area size” correlated with the second type and corresponding to “ID registration number” and “display area size” correlated with the third type and corresponding to “ID registration number”, and “display area size” correlated with the second type and corresponding to “ID registration number” can be larger than “display area size” correlated with third type and corresponding to “ID registration number”.

Subsequently, the communication control unit 22 of the URL server 2 transmits “ID pattern” corresponding to “ID registration number” correlated with each of the first to third types, and “human-readable character” and “display area size” corresponding to the “ID pattern” to the printer 3.

Then, the printer 3 generates an ID background image as described above, and prints human-readable information so as to be superposed on the partial image.

Next, the mobile telephone 5 (FIG. 2) will be described. The mobile telephone 5 has a camera function and an Internet connection function.

The mobile telephone 5 includes a camera, a display unit, operation keys, input keys, and the like.

The mobile telephone 5 incorporates an information processing unit constituted of a CPU, a ROM, and a RAM, and a readable/writable recording medium constituted of, e.g., an electrical erasable and programmable ROM (EEPROM), for storing various programs and data.

The CPU of the mobile telephone 5 executes various information processings according to the programs stored in the ROM or the other recording media.

The RAM provides a working memory used when, for instance, the CPU obtains image data of a receipt, transmits the obtained photographed image data to the URL server 2, or receives a URL from the URL server 2 to connect to the service server 6.

The recording medium stores an application program for photographing a receipt to connect to the service server 6.

By executing this application program, the CPU can realize a function of connecting to the URL server 2 to transmit photographed image data of a receipt, a function of receiving a URL transmitted from the URL server 2 according to the transmitted photographed image data, and a function of connecting to a website designated by the URL by using the received URL.

The recording medium further stores a browser program, and the CPU realizes a browser function with this browser program.

The camera of the mobile telephone 5 includes an optical system constituted of a lens and the like, and a charge coupled device (CCD) for converting an image of an object photographed by the optical system into digital data. When the customer photographs a receipt with the camera, photographed image data of the receipt is generated by the CPU.

The display unit of the mobile telephone 5 includes, e.g., a liquid crystal display, and displays not only information regarding a call such as a phone number but also various screens transmitted from a website via the Internet by a browser.

The operation keys of the mobile telephone 5 are disposed so that the customer can execute various screen operations on a screen displayed on the display unit, such as selection of an icon displayed on the display unit, or selection of a link.

The input keys of the mobile telephone 5 are used to enter numerals, characters, symbols, or the like to the mobile telephone 5.

The receipt is photographed with the mobile telephone 5 thus configured to enable automatic connection to the website designated by the ID background image of the receipt.

According to this embodiment, the Fourier transform of the data of the photographed image and the extraction of the ID patter are carried out by the URL server 2. However, those processings may be executed by the mobile telephone 5 and the extracted ID pattern may be transmitted from the mobile telephone 5 to the URL server 2.

In this case, the application program stored in the recording medium contains information written to enable the CPU to execute processing of subjecting the data of the photographed image to the Fourier transform and processing of extracting the ID pattern from data obtained after the Fourier transform.

According to this embodiment, the processing of photographing the receipt or the like is carried out by the mobile telephone 5. However, a similar function may be realized by a terminal of another type.

For example, a personal digital assistance (PDA), a game machine, a personal computer, or the like which includes a camera and the application may be employed.

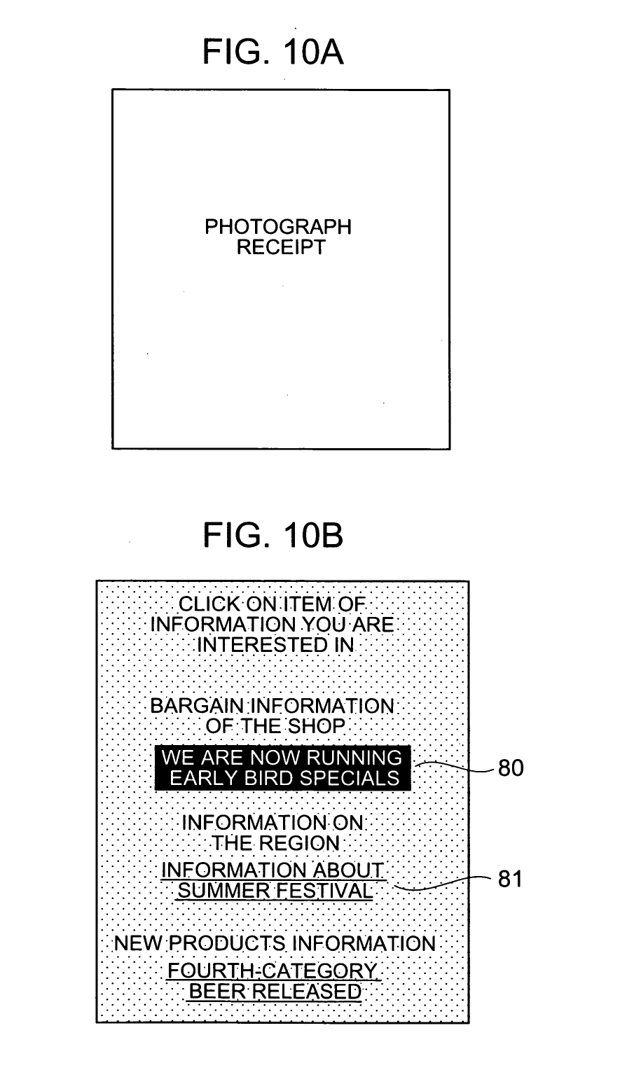

FIGS. 10A and 10B are explanatory diagrams showing examples of screens displayed on the display unit of the mobile telephone 5.

FIG. 10A shows an example of a screen displayed on the display unit of the mobile telephone 5 when the application is started in the mobile telephone 5.

In the example of FIG. 10A, an instruction such as “photograph receipt” for prompting the customer to photograph a receipt is displayed on the display unit. The customer photographs a receipt received at the time of checkout according to the instruction, with the camera of the mobile telephone 5.

FIG. 10B shows an example of a screen displayed on the display unit of the mobile telephone 5when the mobile telephone 5 is connected to a website run by the service server 6.

When the customer photographs the receipt, the mobile telephone 5 executes a series of processings of transmitting photographed image data to the URL server 2, connecting to the service server 6 by using a URL thus sent from the URL server 2, and interpreting and displaying a top screen sent from the service server 6 by the browser.

The top screen displays a button 80 indicating “we are now running early bird specials” corresponding to “bargain information of the shop”, or a button 81 indicating “information about summer festival” corresponding to “information on the region”, and the like.

The customer can select desired one of the buttons by operating the operation keys or the input keys of the mobile telephone 5.

For example, when the button 80 is selected, screen data regarding “we are now running early bird specials” is transmitted from a service server which runs the website having this screen data and displayed on the display unit. When the button 81 is selected, screen data regarding “information about summer festival” is transmitted from a service server which runs the website having this screen data and displayed on the display unit.

Next, the service server 6 (FIG. 2) will be described.

The service server 6 is a web server which runs a website designated by a URL.

An operator of the website can provide characters, static images, moving images, voices, link information, and the like to a terminal device on the website.

A hardware configuration of the service server 6 is basically similar to that of the URL server 2.

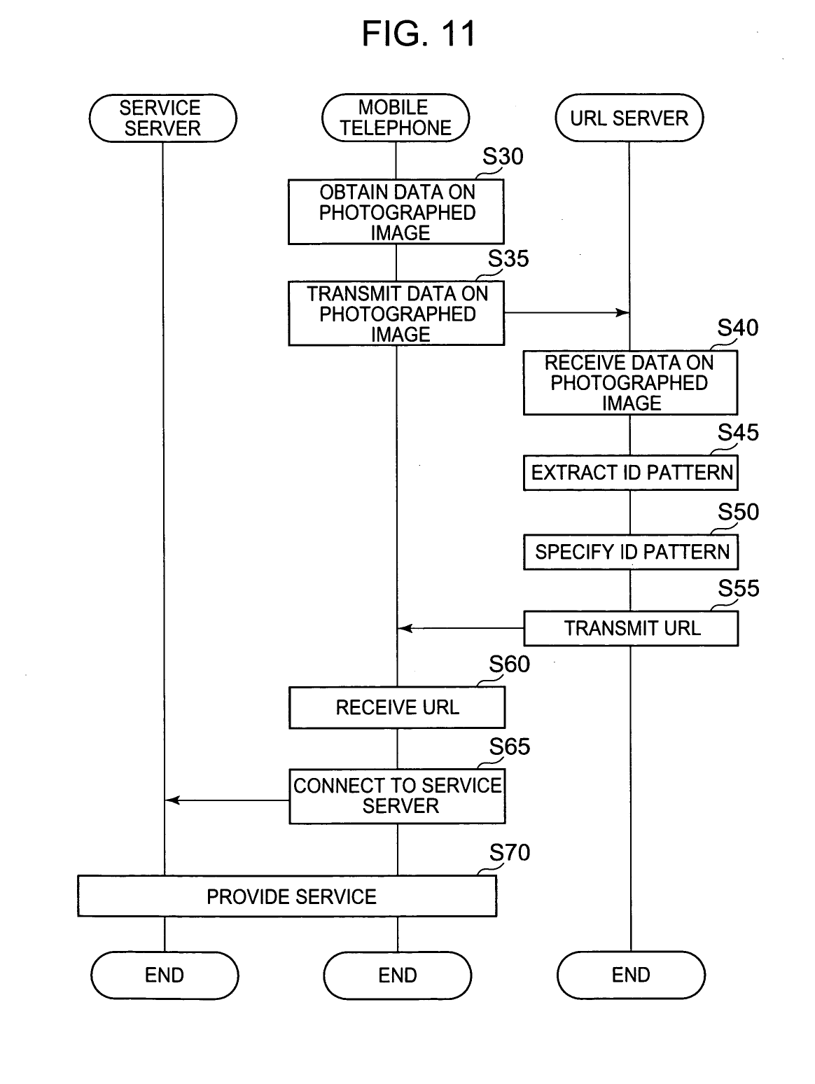

FIG. 11 is a flowchart showing a procedure performed when the mobile telephone 5 connects to the service server 6.

First, the customer requests for issuance of a receipt at the shop at the time of checkout. Then, the application of the mobile telephone 5 is started to photograph the receipt with the mobile telephone 5. Accordingly, the mobile telephone 5 obtains photographed image data of the receipt (Step 30).

The mobile telephone 5 connects to the URL server 2 to transmit the obtained photographed image data to the URL server 2 (Step 35).

The URL server 2 receives the data of the photographed image from the mobile telephone 5 (Step 40).

Then, the URL server 2 subjects the data of the photographed image to the Fourier transform, and extracts an ID pattern from data obtained after the Fourier transform (Step 45).

The URL server 2 specifies the ID pattern contained in the data of the photographed image by comparing the extracted ID pattern with an ID pattern preregistered in the ID database (Step 50).

After the ID pattern has been specified, the URL server 2 obtains a URL correlated with the ID pattern from the ID database and transmits the URL to the mobile telephone 5 (Step 55).

The mobile telephone 5 receives the URL from the URL server 2 (Step 60), and connects to the service server 6 (Step 65).

The service server 6 accepts the connection from the mobile telephone 5, transmits top page screen data to the mobile telephone 5, and continuously provides services to the mobile telephone 5 (Step 70).

The embodiment can provide the following advantages.

It is possible to prevent pieces of inorganic image information from being arrayed, and to efficiently print information obtained by imaging specific information, and multiple pieces of human-readable information, on a limited printing space.

The configuration shown in the embodiment is only an example, and the present invention is not limited thereto.

For example, according to this embodiment, the Fourier transform is employed to embed the ID pattern using the frequency domain. However, this is only an example, and other transforms such as discrete cosine transform (DCT) and wavelet transform may be used needless to say.

According to this embodiment, as an example, an ID background image is printed in a receipt issued at a shop at the time of checkout. However, the purpose of use of the ID background image is not limited to this. For example, the ID background image can be applied to various printed matters such as a magazine, a newspaper, and a poster. Moreover, the ID background image can be displayed not only on the printed matter but also on a display unit of a display or the like.

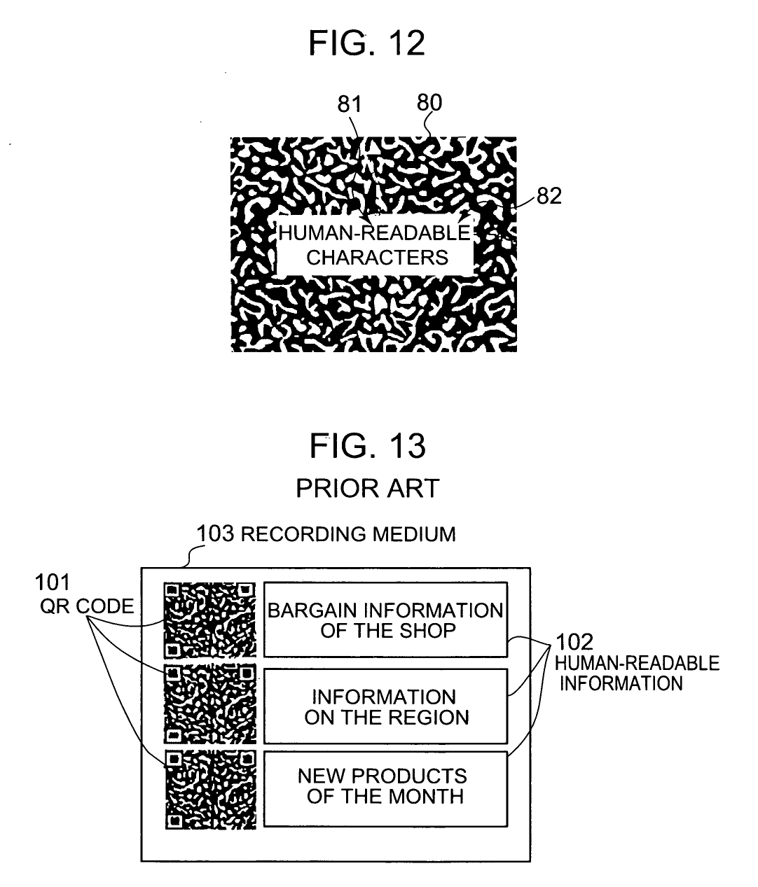

The partial image can also be changed as occasion demands. FIG. 12 shows a modified example of the partial image.

According to this example, a blank area 82 is provided in the center of a partial image 80, and human-readable information 81 is printed in the blank area 82. Accordingly, by making the area for printing the human-readable information 81 and its surroundings blank, the human-readable information 81 can be printed to be viewed more easily.

Even when about 50% of the ID background image is lost, the ID background image can be restored to a level at which the ID pattern can be identified, so a part of such an ID background screen can also be deleted.

The URL server 2 may subject the plurality of ID patterns to the inverse Fourier transform to generate an ID background image, binarize the ID background image (equivalent to the ID background of image 12 of FIG. 1), and transmit the binarized ID background image to the printer 3.

For example, the URL server 2 further includes a dispersed image generation unit and a printing image generation unit.

The dispersed image generation unit of the URL server 2 may disperse an ID pattern of the storage unit 21 and divide an image generated by the dispersion into a plurality of partial images whose number is equal to the number of human-readable characters associated with the ID pattern, or individually disperse a plurality of ID patterns to generate a plurality of partial images.

As in the case of the dispersed image generation unit 27 shown in FIG. 5, the dispersed image generation unit of the URL server 2 may adjust the sizes of partial images based on the display area size or partial image size designation information stored in the storage unit 21.

The printing image generation unit of the URL server 2 generates a printing image having each partial image superposed on human-readable information so that multiple pieces of human-readable information associated with the disposed ID pattern stored in the storage unit 21 can overlap the dispersed image constituted of the plurality of partial images.

When the dispersed image generation unit of the URL server 2 individually disperses the plurality of ID patterns to generate a plurality of partial images, the printing image generation unit of the URL server 2 generates a printing image where the partial images and human-readable information corresponding to the partial images are superposed on each other.

The communication control unit 22 of the URL server 2 transmits the generated printing image to the printer 3.

In the printer 3, when the reception unit 25 receives the printing image, the printing image is stored in the data storage unit 26. When the information input unit 29 receives input information, the printing unit 28 prints an image together with the input information according to the printing image of the data storage unit 26.

In this case, since the URL server 2 transmits an ID background image containing human-readable information to the printer 3, image processing of the printer 3 is unnecessary.

If the ID background image containing binarized human-readable information is transmitted, it is possible to reduce the amount of data transmitted from the URL server 2 to the printer 3 as compared with the case of transmitting the ID background image containing human-readable information before binarization.

The URL server 2 may execute the process up to the inverse Fourier transform, and the printer 3 may execute binarization.

Through an operation of the user, the information input unit 29 may receive an ID pattern stored in the URL server 2, and a human-readable character and a size of a display corresponding to the ID pattern. The ID pattern, and the human-readable character and the size of the display corresponding to the ID pattern which are received by the information input unit 29 are stored in the data storage unit 26.

What is claimed is:

1. A printing device, comprising:
a reception unit for receiving specific information for designating a plurality of websites;
an input unit for receiving human-readable information regarding each of the plurality of websites;
a dispersed image generation unit for generating a dispersed image including a plurality of partial images in which the specific information is dispersed; and
a printing section for printing the dispersed image and the human-readable information in a superposed manner.

2. A printing device, comprising:
a reception unit for receiving multiple pieces of specific information to specify predetermined websites;
an input unit for receiving human-readable information regarding the specific information received by the reception unit;
a dispersed image generation unit for generating a dispersed image including a plurality of partial images in which the multiple pieces of specific information are dispersed; and
a printing unit for printing the dispersed image and the human-readable information regarding the specific information in a superposed manner.

3. A printing device according to claim 2, wherein:
the multiple pieces of human-readable information respectively correspond to the multiple pieces of specific information; and
the dispersed image generation unit generates the plurality of partial images by dispersing each of the multiple pieces of specific information, and prints the partial images and the human-readable information corresponding to the partial images in a superposed manner.

4. A printing device according to claim 1, further comprising a designation information reception unit for receiving designation information for designating sizes of the plurality of partial images,
wherein the dispersed image generation unit decides on sizes of the partial images according to the designation information.

5. A printing device according to claim 2, further comprising a designation information reception unit for receiving designation information for designating sizes of the plurality of partial images,
wherein the dispersed image generation unit decides on sizes of the partial images according to the designation information.

6. A printing device according to claim 3, further comprising a designation information reception unit for receiving designation information for designating sizes of the plurality of partial images,
wherein the dispersed image generation unit decides on sizes of the partial images according to the designation information.

7. An information providing system, comprising:
a printing device; and
a printing control device for communicating with the printing device, wherein:
the printing control device comprises:
a storage unit for storing specific information for designating a plurality of websites and human-readable information regarding each of the plurality of websites;
a dispersed image generation unit for generating a dispersed image including a plurality of partial images in which the specific information stored in the storage unit is dispersed;
a printing image generation unit for generating a printing image in which the dispersed image generated by the dispersed image generation unit and the human-readable information stored in the storage unit are superposed on each other; and
a transmission unit for transmitting the printing image generated by the printing image generation unit to the printing device, and
the printing device comprises:
a reception unit for receiving the printing image; and
a printing unit for printing an image according to the printing image received by the reception unit.

8. An information providing system, comprising:
a printing device; and
a printing control device for communicating with the printing device, wherein:
the printing control device comprises:
a storage unit for storing multiple pieces of specific information for designating predetermined websites and human-readable information regarding the specific information;
a dispersed image generation unit for generating a dispersed image including a plurality of partial images in which the multiple pieces of specific information stored in the storage unit are dispersed;
a printing image generation unit for generating a printing image in which the dispersed image and the human-readable information regarding the specific information are superposed on each other; and
a transmission unit for transmitting the printing image generated by the printing image generation unit to the printing device, and
the printing device comprises:
a reception unit for receiving the printing image; and
a printing unit for printing an image according to the printing image received by the reception unit.

9. An information providing system according to claim 7, wherein:
the storage unit further stores designation information for designating sizes of the plurality of partial images, and
the dispersed image generation unit decides on sizes of the partial images according to the designation information stored in the storage unit.

10. An information providing system according to claim 8, wherein:
the storage unit further stores designation information for designating sizes of the plurality of partial images, and
the dispersed image generation unit decides on sizes of the partial images according to the designation information stored in the storage unit.

11. A printing method, which is implemented by a printing device, comprising:
a reception step of receiving specific information for designating a plurality of websites;
an input step of receiving human-readable information regarding each of the plurality of websites;
a dispersed image generation step of generating a dispersed image including a plurality of partial images in which the specific information is dispersed; and
a printing step of printing the dispersed image and the human-readable information in a superposed manner.

12. A printing method implemented by a printing device, comprising:
a reception step of receiving multiple pieces of specific information for specifying predetermined websites;
an input step of receiving human-readable information regarding the specific information;
a dispersed image generation step of generating a dispersed image including a plurality of partial images in which the multiple pieces of specific information are dispersed; and
a printing step of printing the dispersed image and the human-readable information regarding the specific information in a superposed manner.

13. A printing method implemented by an information providing system comprising a printing device, and a printing control device for communicating with the printing device and storing specific information for designating a plurality of websites and human-readable information regarding each of the plurality of websites,
the method comprising:
a dispersed image generation step of generating, by the printing control device, a dispersed image including a plurality of partial images in which the specific information is dispersed;
a printing image generation step of generating, by the printing control device, a printing image in which the dispersed image and the human-readable information are superposed on each other;
a transmission step of transmitting, by the printing control device, the printing image to the printing device;
a reception step of receiving, by the printing device, the printing image; and
a printing step of printing, by the printing device, an image according to the printing image.

14. A printing method implemented by an information providing system comprising a printing device, and a printing control device which communicates with the printing device and stores multiple pieces of specific information for designating predetermined websites and multiple pieces of human-readable information regarding each of the multiple pieces of specific information,
the method comprising:
a dispersed image generation step of generating, by the printing control device, a dispersed image including a plurality of partial images in which the multiple pieces of specific information are dispersed;
a printing image generation step of generating, by the printing control device, a printing image in which the dispersed image and the human-readable information regarding the specific information are superposed on each other;
a transmission step of transmitting, by the printing control device, the printing image to the printing device;
a reception step of receiving, by the printing device, the printing image; and
a printing step of printing, by the printing device, an image according to the printing image.

15. A printed matter, wherein a dispersed image having specific information for designating a plurality of websites dispersed therein and including partial images equal in number to the plurality of websites, and pieces of human-readable information equal in number to the plurality of websites are superposed on each other.

16. A printed matter wherein a dispersed image having multiple pieces of specific information for specifying a predetermined website dispersed therein and including partial images equal in number to the multiple pieces of specific information, and pieces of human-readable information equal in number to the multiple pieces of specific information are superposed on each other.
